(19) United States
(12) Patent Application Publication
(10) Pub. No.: US 2026/0062581 A1
(43) Pub. Date: Mar. 5, 2026

(54) INVISIBLE FLUORESCENT SOLVENT INK JET INK COMPOSITIONS

(71) Applicant: VIDEOJET TECHNOLOGIES INC., Wood Dale, IL (US)

(72) Inventors: Linfang Zhu, Woodridge, IL (US); Fengfei Xiao, Glenview, IL (US); Jeffrey Pierce, Auruoa, IL (US); Yongman Kim, Buffalo Grove, IL (US); Mark Flanigan, Chicago, IL (US)

(73) Assignee: VIDEOJET TECHNOLOGIES INC., Wood Dale, IL (US)

(21) Appl. No.: 19/380,584

(22) Filed: Nov. 5, 2025

Related U.S. Application Data
(63) Continuation of application No. PCT/US2024/030841, filed on May 23, 2024.
(60) Provisional application No. 63/504,592, filed on May 26, 2023.

(51) Int. Cl. C09D 11/50; C09B 57/02; C09D 11/033; C09D 11/037; C09D 11/328; C09D 11/36; C09D 11/38; C09D 11/52; C09K 11/06

(52) U.S. Cl. CPC C09D 11/50; C09B 57/02; C09D 11/033; C09D 11/037; C09D 11/328; C09D 11/36; C09D 11/38; C09D 11/52; C09K 11/06; C09K 2211/1018

(57) ABSTRACT

Described herein are invisible fluorescent solvent ink jet ink compositions that include a fluorescent colorant comprising a coumarin, a solvent, a binder resin, and a conductive agent.

### CROSS-REFERENCE TO RELATED APPLICATIONS

This application is a continuation of PCT Application No. PCT/US2024/030841, filed May 23, 2024 which claims the benefit of priority to U.S. Provisional Patent Application No. 63/504,592, filed on May 26, 2023, the disclosure of which is hereby incorporated by reference in its entirety.

### FIELD

The present technology generally relates to ink compositions for use in printers, and in particular to invisible fluorescent solvent ink jet ink compositions that include a fluorescent colorant comprising a coumarin, a solvent, a binder resin, and a conductive agent.

### BACKGROUND

Fluorescent inks are widely used in applications where covert (invisible ink) or overt features can be read visually or by a sensor. Invisible fluorescent dyes are used in applications where an invisible fluorescent ink becomes visible under excitation by UV light. Common invisible fluorescent dyes include stilbene derivatives, such as 4,4′-bis(2-benzoxazolyl) stilbene and 4,4′-diamino-2,2′-stilbenedisulfonic acid; biphenyl derivatives, such as 4,4′-diamino[1,1′-biphenyl]-2,2′-disulfonic acid and benzidine-3-sulfonic acid; pyrazolines, such as 1,3-dipheny-5-(4-idophenyl)-2-pyrazoline; bis(benzoxazol-2-yl) derivatives, such as 2,5-bis(5-tert-butyl-benzoxazol-2-yl)thiophene; and coumarin derivatives such as 7-amino-4-methylcoumarin and 7-hydroxycoumarin.

Formulating fluorescent inks for ink jet applications has several challenges. For instance, commercially available fluorescent inks have used successfully in many applications when it is desirable that the printed code remains invisible to the naked eye but emits visible light under UV excitation. However, such commercially available fluorescent inks have limited solubility in common ink jet ink solvents, such as MEK and ethanol. As a result of the limited solubility, the amount of dye that can be used in a MEK-based ink is limited to about 0.2% to about 0.5% by weight of the compositions. Printer uptime reliability is noticeably and negatively impacted when the amount of dye is increased beyond about 0.2% by weight of the composition.

To optimize printer reliability and fluorescent intensity, the amount of fluorescent dye in the commercially available ink is at about 0.2% by weight of the composition. With this practical limit on the amount of fluorescent dye, the fluorescent intensity of the commercially available ink is sometimes not sufficient for a sensor to detect the printed code, especially on high-speed production lines when the size of the printed image has to be reduced to achieve desired speeds. The result is that there is less fluorescence for the sensor to detect the image, and there is also less time for the sensor to detect due to the higher speeds. Increasing the amount of dye in the commercially available ink will improve ink fluorescence; however, at the expense of poorer printer reliability. Thus, there exists a need to develop compositions of invisible fluorescent solvent ink jet ink having improved fluorescence intensity and optimizes printer reliability with acceptable printing speed.

This disclosure addresses these needs by providing invisible fluorescent solvent ink jet ink compositions comprising a fluorescent colorant comprising a coumarin, a solvent, a binder resin, and a conductive agent.

### SUMMARY

Provided in one aspect is an ink jet ink composition comprising:
a fluorescent colorant comprising a coumarin,
a solvent,
a binder resin, and
a conductive agent.

In some embodiments, the coumarin comprises a 7-hydroxy coumarin or a 7-(substituted amino) coumarin. In some embodiments, the coumarin comprises 7-diethylamino-4-methylcoumarin. In some embodiments, the coumarin does not comprise 3-phenyl-7-(1,2H-napthotriazolyl)-coumarin and/or the fluorescent colorant does not comprise 3-phenyl-7-(1,2H-napthotriazolyl)-coumarin.

In some embodiments, the fluorescent colorant has one or more of:
(a) a wavelength of maximum absorption from about 330 nm to about 400 nm, preferably from about 345 nm to about 385 nm; and
(b) a peak emission wavelength of from about 400 nm to about 600 nm, preferably from about 430 nm to about 530 nm.

In some embodiments, the fluorescent colorant is present in amount of from about 0.3% to about 5% by weight of the composition, preferably from about 0.6% to about 3% by weight of the composition.

In some embodiments, the solvent comprises one or more of one or more of ketones, esters, alcohols, lactates, glycols, glycol ethers, glycol ether acetates, and glycol ether esters. In some embodiments, the solvent comprises methyl ethyl ketone, methyl propyl ketone, diethyl ketone, methyl isopropyl ketone, cyclohexanone, cyclopentanone, acetone, ethanol, n-propanol, iso-propanol, n-butanol, methyl acetate, ethyl acetate, n-propyl acetate, isopropyl acetate, ethyl lactate, butyl lactate, propylene glycol, and propylene glycol methyl ether acetate.

In some embodiments, the solvent is present in an amount of at least about 50% by weight of the composition. In some embodiments, the solvent is present in an amount of from about 50% to about 90% by weight of the composition or from about 75% to about 85% by weight of the composition.

In some embodiments, the binder resin comprises one or more of acrylic resins, styrene acrylic resins, copolymer of styrene and allyl alcohol, ketone resins, aldehyde resins, polyketone resins, natural resins or modified natural resins such as rosin esters and terpene modified resins, sulfonamide resin, sulfonamide-formaldehyde resin, toluene-sulfonamide resin, bisphenol A toluene sulfonamide resin, cellulose esters such as cellulose acetate butyrate and cellulose acetate propionate, cellulose ethers such as ethyl cellulose, polyvinyl butyral, polyurethane, phenolic resin, modified phenolic resin, polyamide resins, vinyl resins for example copolymers of vinyl chloride and vinyl acetate with or without a third monomer, polyvinyl alcohol, polyvinyl acetate, nitrocellulose resin, polyester resins, and any combinations thereof, preferably one or more of preferred resins are acrylic resins, styrene acrylic resins, copolymer of styrene and allyl alcohol, ketone resins, aldehyde resins, polyketone resins, natural resins or modified natural resins such as rosin esters and terpene resins, sulfonamide resin, sulfonamide-formaldehyde resin, toluene-sulfonamide resin, bisphenol A toluene sulfonamide resin, cellulose ethers such as ethyl cellulose, cellulose esters such as cellulose acetate butyrate and cellulose acetate propionate, cellulose ethers such as ethyl cellulose, polyvinyl butyral, and any combinations thereof.

In some embodiments, the binder resin does not comprise nitrocellulose. In some embodiments, the binder resin comprises one or more binder resins having a weight average molecular weight of less than about 50,000 Dalton, preferably less than about 30,000 Dalton, and even more preferably less than about 15,000 Dalton. In some embodiments, the binder resin is present in an amount of from about 10% to about 30% by weight of the composition, preferably from about 15% to about 25%.

In some embodiments, the conductive agent comprises one or more of an organic ammonium salt, an organic bromide salt, an organic phosphonium salt, an organic borate salt and an organic phosphate salt. In some embodiments, the conductive agent comprises one or more of a tetraalkylammonium salt. In some embodiments, the conductive agent comprises one or more of tetrabutylammonium hexafluorophosphate, tetrapropylammonium hexafluorophosphate, tetraethylammonium hexafluorophosphate, tetramethylammonium hexafluorophosphate, tetrabutylammonium tetraphenylborate, tetrabutylammonium tetrabutylborate, tetramethylammonium bromide, tetraethylammonium bromide. tetrabutylammonium bromide, tetrapropylammonium bromide, and tetrabutylammonium nitrate.

In some embodiments, the conductive agent is present in an amount of from about 0.5% to about 5% by weight of the composition, preferably from about 1% to about 3%.

In some embodiments, the compositions described herein may further comprise one or more of a humectant, a co-solvent, a co-resin, a defoamer, an adhesion promoter, a plasticizer, a dispersing agent, a surfactant, and a corrosion inhibitor.

In some embodiments, the composition has a viscosity of from about 2 to about 6 cP at about 25° C., preferably from about 3 to about 5 cP at about 25° C. In some embodiments, the composition has an electrical resistivity ranging from about 1000 to about 2000 ohm-cm at about 25° C.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

Described herein are invisible fluorescent solvent ink jet ink compositions comprising a fluorescent colorant comprising a coumarin, a solvent, a binder resin, and a conductive agent. The compositions described herein have exceptional solubility in ink jet solvents, such as MEK and ethanol, thereby allowing a greater amount of dye to be incorporated into the composition and resulting in improved fluorescent intensity. Also, the compositions described herein also have excellent printer reliability. The compositions described herein are an improvement over commercially available invisible fluorescent inks, which have limited solubility in typical ink solvents and limited fluorescence intensity.

This disclosure recognizes that the coumarin dyes, such as 7-diethylamino-4-methylcoumarin, has exceptional solubility in both MEK and ethanol and that fluorescent intensity increases with an increasing amount of fluorescent dye up to a point, reaching an optimal level in an ink jet ink composition after which fluorescent intensity of the dried ink decreases with increasing fluorescent dye concentration. Without wishing to be bound to any theory, it is hypothesized that the fluorescent dye molecules start to self-quench when the dye molecules get too close together as dye concentration increases. Further, this disclosure recognizes that by increasing the amount of the total solids, such as by using any one of the resins described herein, a higher level of optimum fluorescence of the ink can be achieved. Without wishing to be bound by theory, increasing the amount of total solids separates the dye molecules further away from each other, therefore increasing the concentration of dye when self-quenching starts to occur in the dried ink.

As shown in the Examples, the invisible fluorescent solvent ink jet ink compositions formulated in accordance with this disclosure, such as those using a coumarin dye and one or more of the binder resins described herein, are compositions that have greater dye concentration and greater total solids than conventional invisible fluorescent solvent ink jet ink compositions. Furthermore, the invisible fluorescent solvent ink jet ink compositions described herein have a fluorescent intensity that is up to 3-fold greater than that observed with a comparative ink formulation (e.g., Dye A, a commercially available fluorescent ink comprising 5-bis(5-tert-butyl-benzoxazol-2-yl)thiophene (also known as 2,5-thiophenediylbis(5-tert-butyl-1,3-benzoxazole)). In some embodiments, the ink jet ink composition has a fluorescent intensity that is 1-fold, 2-fold, 3-fold greater as compared to a comparative ink formulation.

Provided in one aspect is an ink jet ink composition comprising:
a fluorescent colorant comprising a coumarin,
a solvent,
a binder resin, and
a conductive agent.

### Fluorescent Colorant

The ink jet ink composition described herein comprise a fluorescent colorant. As described herein, the fluorescent colorant comprises one or more coumarin dyes.

Suitable examples of coumarin dyes include those comprising a 7-hydroxy coumarin or a 7-(substituted amino) coumarin. Other examples of suitable coumarin fluorescent dyes include 7-diethylamino-4-methylcoumarin, 7-(diethylamino)coumarin-3-carboxylic acid, 7-amino-4-methylcoumarin, 7-amino-3-phenylcoumarin, 7-hydroxycoumarin, 7-hydroxycoumarin-3-carboxylic acid, 6,8-difluoro-7-hydroxy-4-methylcoumarin, 6,7-bis(acetyloxy)coumarin, 3-(3-phenyl-2-oxazolyl)-7-(diethylamino)coumarin, 3-(4-phenyl-2-oxazolyl)-7-(diethylamino)coumarin, 3-(2-benzothiazolyl)-7-(diethylamino) coumarin. In some embodiments, the coumarin comprises 7-diethylamino-4-methylcoumarin (e.g., Fluorescent brightener 140).

In some embodiments, the fluorescent colorant (e.g., the coumarin dye) does not comprise 3-phenyl-7-(1,2H-napthotriazolyl)-coumarin.

Suitable fluorescent colorants include those having a solubility greater than about 1%, and more preferably greater than about 2% in the ink solvent or solvent mixture in the temperature range the ink can be exposed to, for example from about −15° C. to about 60° C. The solubility of fluorescent dyes in solvents usually decreases with decreasing temperatures, making it even more challenging to achieve printer reliability in cold environments due to dye precipitation which can lead to nozzle restriction and jet deviation. In hot environments, while solubility is less a concern, due to high evaporation of solvents near the nozzle, the concentration of the dye can rise rapidly at the nozzle, leading to similar issues.

In some embodiments, the fluorescent colorant has one or more of: (a) a wavelength of maximum absorption from about 330 nm to about 400 nm, preferably from about 345 nm to about 385 nm; and (b) a peak emission wavelength of from about 400 nm to about 600 nm, preferably from about 430 nm to about 530 nm.

In some embodiments, the fluorescent colorant has a wavelength of maximum absorption from about 330 nm to about 400 nm, including about 330 nm, about 335 nm, about 340 nm, about 345 nm, about 350 nm, about 355 nm, about 360 nm, about 365 nm, about 370 nm, about 375 nm, about 380 nm, about 385 nm, about 390 nm, about 395 nm, and about 400 nm. In some embodiments, the fluorescent colorant has a wavelength of maximum absorption from about 345 nm to about 385 nm.

In some embodiments, the fluorescent colorant has a peak emission wavelength of from about 400 nm to about 600 nm, including about 400 nm, about 405 nm, about 410 nm, about 415 nm, about 420 nm, about 425 nm, about 430 nm, about 435 nm, about 440 nm, about 445 nm, about 450 nm, about 455 nm, about 460 nm, about 465 nm, about 470 nm, about 475 nm, about 480 nm, about 485 nm, about 490 nm, about 495 nm, about 500 nm, about 505 nm, about 510 nm, about 515 nm, about 520 nm, about 525 nm, about 530 nm, about 535 nm, about 540 nm, about 545 nm, about 550 nm, about 555 nm, about 560 nm, about 565 nm, about 570 nm, about 575 nm, about 580 nm, about 585 nm, about 590 nm, about 595 nm, and about 600 nm. In some embodiments, the fluorescent colorant has a peak emission wavelength of from about 430 nm to about 530 nm.

In some embodiments, the fluorescent colorant is present in an amount of from about 0.3% to about 5% by weight of the composition, including about 0.3%, about 0.4%, about 0.5%, about 0.6%, about 0.7%, about 0.8%, about 0.9%, about 1%, about 1.5%, about 2%, about 2.5%, about 3%, about 3.5%, about 4%, about 4.5%, and about 5%. In some embodiments, the fluorescent colorant is present in an amount of from about 0.6% to about 3% by weight of the composition.

### Solvents

The ink jet ink compositions described herein comprise a solvent. Suitable examples include but are not limited to one or more of ketones, esters, alcohols, lactates, glycols, glycol ethers, glycol ether acetates, and glycol ether esters. Suitable examples of ketones include but are not limited to acetone, methyl ethyl ketone, 3-methyl-2-butanone (methyl isopropyl ketone), 2-pentanone (methyl propyl ketone), diethyl ketone, methyl isobutyl ketone, cyclopentanone, and cyclohexanone. Suitable examples of esters include but are not limited to methyl acetate, ethyl acetate, n-propyl acetate, isopropyl acetate, n-butyl acetate, t-butyl acetate, amyl acetate, methyl lactate, ethyl lactate, n-propyl lactate, isopropyl lactate, n-butyl lactate, and methoxypropyl acetate. Suitable examples of alcohols include but are not limited to methanol, ethanol, n-propanol, isopropanol, n-butanol, t-butanol, n-pentanol, and n-hexanol. Suitable examples of glycols include but are not limited to ethylene glycol, propylene glycol, glycerin, and diethylene glycol. Suitable examples of glycol ethers or glycol ether acetates include but are not limited to methoxypropanol, dipropylene glycol methyl ether, propylene glycol propyl ether, propylene glycol butyl ether, tripropylene glycol methyl ether, butylene glycol methyl ether, dibutylene glycol methyl ether, dipropylene glycol methyl ether acetate, propylene glycol propyl ether acetate, propylene glycol butyl ether acetate.

In some embodiments, the solvent comprises one or more of ketones, esters, alcohols, lactates, glycols, glycol ethers, glycol ether acetates, glycol ether acetates and glycol ether esters. In some embodiments, the solvent comprises one or more of methyl ethyl ketone, methyl propyl ketone, diethyl ketone, methyl isopropyl ketone, cyclohexanone, cyclopentanone, acetone, ethanol, n-propanol, iso-propanol, n-butanol, methyl acetate, ethyl acetate, n-propyl acetate, isopropyl acetate, ethyl lactate, butyl lactate, propylene glycol, and propylene glycol methyl ether acetate.

In some embodiments, the solvent is present in an amount of at least about 50% by weight of the composition, including at least about 55%, at least about 60%, at least about 65%, at least about 70%, at least about 75%, at least about 80%, at least about 85%, at least about 90%. In some embodiments, the solvent is present in an amount of from about 50% to about 90% by weight of the composition, including about 50%, about 55%, about 60%, about 65%, about 70%, about 75%, about 80%, about 85%, and about 90%. In some embodiments, the solvent is present in an amount of from about 75% to about 85% by weight of the composition.

### Binder Resin

The ink jet ink compositions described herein comprise a binder resin. Binder resins may be used to provide ink adhesion on substrates, thus preventing the damage or loss of the printed marks from the marked surface in product handling after marking. These binder resins may be employed with co-resins. Suitable examples of binder resins include any resins that are soluble or dispersible in the solvents described herein. Other examples of suitable examples of binder resins include one or more of acrylic resins, styrene acrylic resins, copolymer of styrene and allyl alcohol, ketone resins, aldehyde resins, polyketone resins, natural resins or modified natural resins such as rosin esters and terpene modified resins, sulfonamide resin, sulfonamide-formaldehyde resin, toluene-sulfonamide resin, bisphenol A toluene sulfonamide resin, cellulose esters such as cellulose acetate butyrate and cellulose acetate propionate, cellulose ethers such as ethyl cellulose, polyvinyl butyral, polyurethane, phenolic resin, modified phenolic resin, polyamide resins, vinyl resins for example copolymers of vinyl chloride and vinyl acetate with or without a third monomer, polyvinyl alcohol, polyvinyl acetate, nitrocellulose resin, polyester resins, and any combinations thereof, preferably one or more of preferred resins are acrylic resins, styrene acrylic resins, copolymer of styrene and allyl alcohol, ketone resins, aldehyde resins, polyketone resins, natural resins or modified natural resins such as rosin esters and terpene resins, sulfonamide resin, sulfonamide-formaldehyde resin, toluene-sulfonamide resin, bisphenol A toluene sulfonamide resin, cellulose ethers such as ethyl cellulose, cellulose esters such as cellulose acetate butyrate and cellulose acetate propionate, cellulose ethers such as ethyl cellulose, polyvinyl butyral, and any combinations thereof.

Acrylic resins may be a homopolymer or incorporate two or more monomers with or without specific functional groups. Functionalized acrylic resins may be derived from an alkyl type monomer, such as a methacrylate, plus a functionalized monomer, such as acrylic acid or methacrylic acid; basic monomers such as amino acrylates; or neutral functional monomers that contain hydroxyl groups. Examples of suitable resins are those from Dow Chemical Corporation sold under the trade-name ACRYLOID or PARALOID or DIANAL resins from Dianal Corporation (e.g., DIANAL PB-204). A specific example of a non-functionalized resin is sold under the trade name PARALOID B-60, which is a methylmethacrylate and butylmethacrylate copolymer with a molecular weight of approximately 50,000 Daltons. CARBOSET® 525 and 527 resin available from Lubrizol, and NEOCRYL® B-725, B-731, B-735, B-810, B-811, B-813, B-814, B-817, B-842, B-890, and B-891 resins, available from Covestro AG. Other suitable acrylic resins and styrene acrylic resins include those having weight average molecular weights less than about 100,000. Other resins are ones that incorporate pendant amine groups as is disclosed in U.S. Pat. No. 4,892,775.

Examples of acrylic resins also include styrene-acrylic resins which can be made by copolymerizing styrene with acrylic monomers such as acrylic acid or methacryl acid, and optionally, with alkyl acrylate monomers, such as methyl acrylate, methyl methacrylate, butyl acrylate, butyl methacrylate, hydroxyethyl acrylate, hydroxyethyl methacrylate, and the like made by BASF, under the trade name JONCRYL®. Examples of JONCRYL® resins include JONCRYL® 500, 586, 611, 678, 680, 682, 683, 690, 693, and 67.

Suitable resins comprising vinyl acetate/vinyl chloride copolymers those under the trade name of VINNOL from Wacker Chemie AG. These include structurally modified carboxyl-vinyl chloride/vinyl acetate polymers (e.g., VINNOL® E15/45M), hydroxyl-modified vinyl chloride/vinyl acetate polymers (e.g., VINNOL® E15/40A), and unmodified vinyl chloride/vinyl acetate polymers (e.g., VINNOL® H14/36). Vinyl acetate/vinyl chloride copolymers with any structural modifications or ratio of vinyl chloride:vinyl acetate may be employed, as long as they are soluble in the carrier.

Examples of polyvinylbutyral resins are PIOLOFORM® BN 18, available from Wacker Chemie AG, MOWITAL® B20H available from Kuraray America, Inc., and S-LEC B Polyvinyl Butyral from Sekisui Products LLC. Examples of ethyl cellulose resins are ETHOCEL available from Dow Chemical. Another example of a cellulose-based resin is CAP-482-0.5 (cellulose acetate propionate) from Eastman Chemical.

Suitable polyurethane resins include those comprising flexible thermoplastic urethanes produced by the reaction of diols and diisocyanates. Examples of diols include ethylene glycol, propylene glycol, propanediol, butanediol, polyethylene glycol, polypropylene glycol, polyethylene glycol adipate diol, polyethylene glycol succinate diol, polytetrahydrofuran diol, and the like. Examples of diisocyanates include 2,4-toluene diisocyanate, 2,6-toluene diisocyanate, 4,4-diphenylmethane diisocyanate, hexamethylene diisocyanate, and the like. Suitable polyurethane resins include those having weight average molecular weights in the range of about 4,000 to about 25,000. Specific examples of polyurethane resins include those sold under the commercial name of SURKOPAK® by BIP (Oldbury) Limited. A variety of grades of polyurethane solutions are sold under this name and include SURKOPAK® 2135, SURKOPAK® 5299, SURKOPAK® 5244, SURKOPAK® 5255, SURKOPAK® 2X, SURKOPAK® 5322, SURKOPAK® 5311, and SURKOPAK® XL. SURKOPAK® 5322 is a polyurethane composed of polypropylene glycol and 4,4′-diphenylmethane diisocyanate and is sold as a solution in a mixed solvent containing ethyl acetate and isopropanol.

Rosin ester resins include SUPERESTER 75 available from Arakawa Chemical and STAYBELITE® Ester 10, which is the glycerol ester of partially hydrogenated wood rosin from Pinova Incorporated.

Other suitable resins include those comprising copolymers of styrene allyl alcohol (e.g., SAA 100) and those comprising cellulose acetate butyrate (e.g., CAB 551-0.01).

In some embodiments, the binder resin comprises one or more of one or more of acrylic resins, styrene acrylic resins, copolymer of styrene and allyl alcohol, ketone resins, aldehyde resins, polyketone resins, natural resins or modified natural resins such as rosin esters and terpene modified resins, sulfonamide resin, sulfonamide-formaldehyde resin, toluene-sulfonamide resin, bisphenol A toluene sulfonamide resin, cellulose esters such as cellulose acetate butyrate and cellulose acetate propionate, cellulose ethers such as ethyl cellulose, polyvinyl butyral, polyurethane, phenolic resin, modified phenolic resin, polyamide resins, vinyl resins for example copolymers of vinyl chloride and vinyl acetate with or without a third monomer, polyvinyl alcohol, polyvinyl acetate, nitrocellulose resin, polyester resins, and any combinations thereof.

In some embodiments, the binder resin comprises one or more of acrylic resins, styrene acrylic resins, copolymer of styrene and allyl alcohol, ketone resins, aldehyde resins, polyketone resins, natural resins or modified natural resins such as rosin esters and terpene resins, sulfonamide resin, sulfonamide-formaldehyde resin, toluene-sulfonamide resin, bisphenol A toluene sulfonamide resin, cellulose ethers such as methyl cellulose and ethyl cellulose, cellulose esters such as cellulose acetate butyrate and cellulose acetate propionate, cellulose ethers such as ethyl cellulose, polyvinyl butyral, and any combinations thereof.

In some embodiments, the binder resin does not comprise nitrocellulose.

Suitable resins include one or more binder resins having a weight average molecular weight of less than about 50,000 Dalton, including less than about 45,000 Dalton, less than about 40,000 Dalton, less than about 35,000 Dalton, less than about 30,000 Dalton, less than about 25,000 Dalton, less than about 20,000 Dalton, and less than about 15,000 Dalton. In some embodiments, the binder resin comprises one or more binder resins having a weight average molecular weight of less than about 50,000 Dalton. In some embodiments, the binder resin comprises one or more binder resins having a weight average molecular weight of less than about 30,000 Dalton. In some embodiments, the binder resin comprises one or more binder resins having a weight average molecular weight of less than about 15,000 Dalton. In some embodiments, the binder comprises one or more binder resins having a weight average molecular weight of greater than about 500 Dalton. In some embodiments, the binder comprises one or more binder resins having a weight average molecular weight of from about 500 Dalton to about 50,000 Dalton.

In some embodiments, the binder resin is present in an amount of from about 5% to about 35% by weight of the composition, including about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, and 35% by weight of the composition. In some embodiments, the binder resin is present in an amount of from about 15% to about 25% by weight of the composition.

### Conductive Agent

The ink jet ink compositions described herein comprise a conductive agent, which can act as a charge carrier in the liquid ink to achieve a desired conductivity or resistivity. Suitable conductive agents include one or more of an organic ammonium salt, an organic bromide salt, an organic phosphonium salt, an organic borate salt, and an organic phosphate salt. Another example of suitable conductive agents includes one or more of a tetraalkylammonium salt. Other examples of suitable conductive agents include ammonium, alkali, and alkaline earth metal salts such as lithium nitrate, lithium thiocyanate, lithium trifluoromethanesulfonate, potassium bromide, and the like; amine salts such as dimethylamine hydrochloride, and hydroxylamine hydrochloride; and ammonium acetate.

Suitable examples of tetraalkylammonium salts include but are not limited to tetrabutylammonium chloride, tetrabutylammonium bromide, tetrabutylammonium acetate, tetrabutylammonium nitrate, tetrabutylammonium hexafluorophosphate, tetrabutylammonium tetrafluoroborate, tetrabutylammonium thiocyanate, tetrapropylammonium chloride, tetrapropylammonium bromide, tetrapropylammonium acetate, tetrapropylammonium nitrate, tetrapropylammonium hexafluorophosphate, tetrapropylammonium tetrafluoroborate, tetrapropylammonium thiocyanate, tetraethylammonium chloride, tetraethylammonium bromide, tetraethylammonium acetate, tetraethylammonium nitrate, tetraethylammonium hexafluorophosphate, tetraethylammonium tetrafluoroborate, tetraethylammonium thiocyanate, tetramethylammonium chloride, tetramethylammonium bromide, tetramethylammonium acetate, tetramethylammonium nitrate, tetramethylammonium hexafluorophosphate, tetramethylammonium tetrafluoroborate, tetramethylammonium thiocyanate, tetrabutylphosphonium chloride, tetrabutylphosphonium bromide, tetrabutylphosphonium acetate, tetrabutylphosphonium nitrate, tetrabutylphosphonium hexafluorophosphate, tetrabutylphosphonium tetrafluoroborate, tetrabutylphosphonium thiocyanate, tetrapropylphosphonium chloride, tetrapropylphosphonium bromide, tetrapropylphosphonium acetate, tetrapropylphosphonium nitrate, tetrapropylphosphonium hexafluorophosphate, tetrapropylphosphonium tetrafluoroborate, tetrapropylphosphonium thiocyanate, tetraethylphosphonium chloride, tetraethylphosphonium bromide, tetraethylphosphonium acetate, tetraethylphosphonium nitrate, tetraethylphosphonium hexafluorophosphate, tetraethylphosphonium tetrafluoroborate, tetraethylphosphonium thiocyanate, tetramethylphosphonium chloride, tetramethylphosphonium bromide, tetramethylphosphonium acetate, tetramethylphosphonium nitrate, tetramethylphosphonium hexafluorophosphate, tetramethylphosphonium tetrafluoroborate, tetramethylphosphonium thiocyanate, tetraphenylphosphonium chloride tetraphenylphosphonium bromide, tetraphenylphosphonium acetate, tetraphenylphosphonium nitrate, tetraphenylphosphonium hexafluorophosphate, tetraphenylphosphonium tetrafluoroborate, tetraphenylphosphonium thiocyanate as well as ammonium acetate. In some embodiments, the conductive agent comprises a cation selected from the group consisting of tetraalkylammonium, tetraarylammonium, tetraalkylphosphonium, tetraarylphosphonium, and any combinations thereof, and an anion selected from the group consisting of hexafluorophosphate, tetrafluoroborate, tetraalkylborate, tetraarylborate, and any combinations thereof. Examples of specific conductive agents include but are not limited to tetrabutylammonium hexafluorophosphate, tetrapropylammonium hexafluorophosphate, tetraethylammonium hexafluorophosphate, tetramethylammonium hexafluorophosphate, tetrabutylammonium tetraphenylborate, tetrabutylammonium tetrabutylborate, tetrabutylammonium tetrafluoroborate, tetrapropylammonium tetrafluoroborate, tetraethylammonium tetrafluoroborate, tetramethylammonium tetrafluoroborate, tetramethylammonium bromide, tetraethylammonium bromide. tetrabutylammonium bromide, tetrapropylammonium bromide, tetrabutylammonium nitrate and any combinations thereof.

In some embodiments, the conductive agent comprises one or more of tetrabutylammonium hexafluorophosphate, tetrapropylammonium hexafluorophosphate, tetraethylammonium hexafluorophosphate, tetramethylammonium hexafluorophosphate, tetrabutylammonium tetraphenylborate, and tetrabutylammonium tetrabutylborate. In some embodiments, the conductive agent comprises tetrabutylammonium bromide or tetrapropylammonium bromide.

In some embodiments, the conductive agent is present in an amount of from about 0.5% to about 5% by weight of the composition, including about 0.5%, about 1%, about 1.5%, about 2%, about 2.5%, about 3%, about 3.5%, about 4%, about 4.5%, and about 5% by weight of the composition. In some embodiments, the conductive agent is present in an amount of from about 1% to about 3% by weight of the composition.

### Additional Components

In some embodiments, any one of the ink jet ink compositions described herein further comprises one or more of a humectant, a co-solvent, a co-resin, a defoamer, an adhesion promoter, a plasticizer, a dispersing agent, a surfactant, and a corrosion inhibitor.

Humectants may be used to prevent drying of the ink on the print head during the printing operation, as well as during storage of the ink. Humectants are typically hydrophilic solvents having high boiling points, such as above 100° C. or from about 150° C. to about 250° C. Suitable humectants include but are not limited to diacetone alcohol, lactates such as ethyl lactate and butyl lactate, glycols, such as ethylene glycol, propylene glycol, glycerin, diglycerin, and diethylene glycol; glycol ethers, such as ethylene glycol dimethyl ether, ethylene glycol diethylether, propyleneglycol methylether, cellosolve, diethylene glycol monoethylether (CARBITOL™) diethylene glycol dimethylether, and diethylene glycol diethylether; dialkyl sulfoxides, such as dimethyl Sulfoxide; and other solvents such as sulfolane and N-methylpyrrolidone. The humectant can be present in an amount of from about 0.1% to about 10% by weight of the ink composition.

Co-solvents may be employed in the ink jet ink compositions described herein. If a co-solvent is used, it is used in an amount smaller than the main solvent and can be any one of the solvents that are described herein. For example, the main solvent is used in an amount of about two, three, four, five, or more times the amount of the co-solvent.

Co-resins can provide improved dispersibility of the pigment and/or stability of the ink composition. An example of a co-resin is an aldehyde resin, such as urea-aldehyde resin or ketone resin.

Defoamers may be used to prevent foaming of the ink during its preparation, as well as during the printing operation. Suitable defoamers include polysiloxane defoamers, such as BYK™ 065 from BYK USA Inc., in Wallingford, Conn. The defoamer can be present in any suitable amount, for example, in an amount of from about 0.01% to about 1% by weight of the ink composition.

The ink jet ink compositions described herein may comprise an adhesion promoter, such as a silane or a polyamine. Suitable adhesion promoters also include monomeric compounds of low molecular weight, although dimeric, trimeric, or higher oligomeric compounds are also contemplated, and these compounds contain one or more reactive groups, e.g., epoxy groups. Examples of suitable silanes include SILQUEST® WETLINK 78 (7-glycidoxypropyl diethoxymethylsilane), SILQUEST® A-link 25 (3-isocyanatopropyltriethoxysilane), SILQUEST® A-Link 35 (3-isocyanatopropyltrimethoxysilane, SILQUEST® Silane A-186 ([3-(3,4-epoxycyclohexyl)ethyltrimethoxysilane), SILQUEST® Silane A-187 (7-glycidoxypropyl trimethoxysilane) SILQUEST® Silane A-1100 (gamma-aminopropyltriethoxysilane), and COATOSIL™ 1770 ([3-(3,4-epoxycyclohexyl)ethyltriethoxysilane), all available from Momentive. Other examples include ADDID 900 (amino-functional trimethoxy silane) and 940 (methacrylic trimethoxy-functional silane), both of which are available from Wacker Silicones Corp. Suitable polyamines include polyalkyleneamines (e.g., polyethyleneimine) and may be further modified by ethoxylation, epoxylation, or silylation. Other examples of polyamines include dendrimers and aminoacrylic polymers, such as disclosed in U.S. Pat. Nos. 5,596,027 and 6,221,933. Polyethyleneimines may be obtained commercially and can be of any suitable molecular weight, such as below a weight average molecular weight of about 10,000. The adhesion promoter can be present in any suitable amount, for example, from about 0.01% to about 3% by weight.

Plasticizers may be used to further enhance the properties, e.g., durability, of the printed message. Examples of suitable plasticizers include phthalate plasticizers, e.g., alkylbenzyl phthalates, butylbenzyl phthalate, dioctyl phthalate, diisobutyl phthalate, dicyclohexyl phthalate, diethyl phthalate, dimethyl isophthalate, dibutyl phthalate, and dimethyl phthalate; esters such as di-(2-ethylhexy)-adipate, diisobutyl adipate, glycerol tribenzoate, sucrose benzoate, dibutyl sebacate, dibutyl maleate, polypropylene glycol dibenzoate, neopentyl glycol dibenzoate, dibutyl sebacate, and tri-n-hexyltrimellitate; phosphates such as tricresyl phosphate, dibutyl phosphate, triethyl citrate, tributylcitrate, acetyl tri-n-butyl citrate; polyurethanes; acrylic polymers; lactates; oxidized oils such as epoxidized soybean oil, oxidized linseed oil; and sulfonamide plasticizers, RIT-CIZER 8 (op-mixture of N-ethyltoluenesulfonamide) available from Rit-Chem Co. The plasticizer can be present in any suitable amount, for example, in an amount of from about 0.01% to about 3% by weight of the ink composition.

Dispersing agents, such as polymeric dispersing agents, may be used to enhance pigment stabilization or reduce sedimentation rate. Hyperdispersants, which are polymeric dispersing agents containing groups with affinity for pigments, may also be employed. An example of a hyperdispersant is SOLSPERSE™ 38500 (an active polymeric dispersant in MPA) available from Lubrizol. A suitable dispersing agent includes BYK® P104S from BYK USA Inc. Other examples of hyperdispersants can be found in the literature, for example, see WO00/63305, the disclosure of which is incorporated by reference. In general, suitable dispersing agents include those available under the trade name SOLSPERSE™ from LubriZol, Inc.; the trade name EFKA from BASF, Inc.; and the tradename of BYK or DISPERBYK from BYK USA Inc. The dispersing agent can be used in any suitable amount, for example, in an amount of from about 0.1% to about 5% by weight by weight of the ink composition.

Surfactants may be used to optimize the wetting and/or drying characteristics of the ink. Suitable surfactants include siloxanes, silicones, silanols, polyoxyalkyleneamines, propoxylated (poly(oxypropylene)) diamines, alkyl ether amines, nonyl phenol ethoxylates, ethoxylated fatty amines, quaternized copolymers of vinylpyrrolidone and dimethyl aminoethyl methacrylate, alkoxylated ethylenediamines, polyethylene oxides, polyoxyalkylene polyalkylene polyamines amines, polyoxyalkylene polyalkylene polyimines, alkyl phosphate ethoxylate mixtures, polyoxyalkylene derivatives of propylene glycol, polyoxyethylated fatty alcohols, and fluorinated surfactants. Examples of a suitable polymeric silicone based surfactant are sold under the trade name SILWET. Examples of fluorinated surfactants include those sold under the trade name ZONYL from Chemours. Specific examples of suitable surfactants include SILWET® L-7622, which is a polyethyleneoxide modified polydimethylsiloxane, available from Momentive, and FC 430, which is a fluoroaliphatic polymeric ester, available from 3M Co. Another specific example of a surfactant is BYK-3550, which is silicone surfactant. An specific example of a siloxane surfactant is ELEMENT14™ PDMS 100. The surfactant can be present in the ink composition in any suitable amount, for example, in an amount of from about 0.01% to about 2% by weight of the ink composition.

Corrosion inhibitors may be used in the ink jet ink compositions described herein. Suitable corrosion inhibitors include benzotriazole and may be present in amount of from about 0.01% to about 2% by weight of the ink composition.

### Ink Jet Ink Compositions

In some embodiments, the ink jet ink composition comprises:
about 0.3% w/w to about 5% w/w of a fluorescent colorant comprising a coumarin,
at least about 50% w/w of a solvent,
about 10% w/w to about 30% w/w of a binder resin, and
about 0.5% w/w to about 5% w/w of a conductive agent.

In some embodiments, any one of the ink jet ink compositions described herein composition has a viscosity of from about 2.0 to about 6.0 cP at about 25° C., including about 2.0 cP, about 2.1 cP, about 2.2 cP, about 2.3 cP, about 2.4 cP, about 2.5 cP, about 2.6 cP, about 2.7 cP, about 2.8 cP, about 2.9 cP, about 3.0 cP, about 3.1 cP, about 3.2 cP, about 3.3 cP, about 3.4 cP, about 3.5 cP, about 3.6 cP, about 3.7 cP, about 3.8 cP, about 3.9 cP, about 4.0 cP, about 4.1 cP, about 4.2 cP, about 4.3 cP, about 4.4 cP, about 4.5 cP, about 4.6 cP, about 4.7 cP, about 4.8 cP, about 4.9 cP, about 5.0 cP, about 5.1 cP, about 5.2 cP, about 5.3 cP, about 5.4 cP, about 5.5 cP, about 5.6 cP, about 5.7 cP, about 5.8 cP, about 5.9 cP, and about 6.0 cP at about 25° C. In some embodiments, any one of the ink jet ink compositions described herein composition has a viscosity of from about 3.0 to about 5.0 cP at about 25° C.

In some embodiments, any one of the ink jet ink compositions described herein has a electrical resistivity of from about 1000 to about 2000 ohm-cm at about 25° C., including about 1000, about 1050, about 1100, about 1150, about 1200, about 1250, about 1300, about 1350, about 1400, about 1450, about 1500, about 1550, about 1600, about 1650, about 1700, about 1750, about 1800, about 1850, about 1900, about 1950, and about 2000 ohm-cm.

### Applications

The ink jet compositions described herein (e.g., invisible fluorescent ink compositions comprising one or more coumarins) are suitable for use for use in security printing and any other applications where invisibility of the code by the naked eye is desired. In addition, the compositions described herein may be used to mark defective material on a continuous film or foil in a web application on high-speed production lines, enabling subsequent online detection, and removal of the defective parts of the film or foil using an fluorescent light sensor.

The present invention, thus generally described, will be understood more readily by reference to the following examples, which are provided by way of illustration and are not intended to be limiting of the present invention.

### EXAMPLES

### Example A

The below table shows the solubility of fluorescent dyes 7-diethylamino-4-methylcoumarin and 2,5-bis(5-tert-butyl-benzoxazol-2-yl) thiophene in the specific solvents and temperatures indicated below.

| | | 2,5-bis(5-tert-butyl- |
|---|---|---|
| | 7-diethylamino-4- | benzoxazol-2-yl) |
| Solubility | methylcoumarin | thiophene |
| MEK, RT | >10% | 1.2% |
| MEK, 5° C. | Not Tested | 1.0% |
| MEK, −15° C. | >10% | 0.1% |
| SDA-3C (denatured | >10% | <0.1% |
| ethanol), RT | | |
| SDA-3C (denatured | 8% | Not Tested |
| ethanol), 5° C. | | |
| SDA-3C (denatured | 3% | Not Tested |
| ethanol), −15° C. | | |

### Example B

Ink jet ink formulations Examples 1-7 were prepared in accordance to the components and amounts listed in the below table. Examples 1-7 used fluorescent brightener 140, which contains 7-diethylamino-4-methylcoumarin as the coumarin dye. The comparative formulation is Dye A, a commercially available fluorescent ink jet formulation comprising 2,5-bis(5-tert-butyl-benzoxazol-2-yl) thiophene as the dye. The general procedures for preparing these ink jet ink formulations included the following steps: 1) dissolving all of the components one by one in the ink vehicle with mixing; and 2) filtering the ink solution.

Example B illustrates that formulation Examples 1-7 exhibited improved fluorescent intensity as compared to the Comparative Example. This example also shows that for a given formulation, best fluorescent intensity can be achieved by optimizing the concentration of the dye in the formulation. For instance, Examples 1-7 exhibited a fluorescent intensity was up to about 3 times greater than the Comparative Example.

| | Comp. | Ex. | Ex. | Ex. | Ex. | Ex. | Ex. | Ex. |
|---|---|---|---|---|---|---|---|---|
| % | Example | 1 | 2 | 3 | 4 | 5 | 6 | 7 |
| MEK | Dye A | 55.50 | 53.90 | 53.20 | 65.15 | 64.97 | 64.79 | 54.40 |
| SDA-3C | | 11.00 | 11.00 | 11.00 | 8.05 | 8.03 | 8.01 | 11.00 |
| (Ethanol) | | | | | | | | |
| Isopropyl | | 12.00 | 12.00 | 12.00 | — | — | — | 12.00 |
| acetate | | | | | | | | |
| JONCRYL | | 19.00 | 19.00 | 19.00 | — | — | — | 19.00 |
| 67 | | | | | | | | |
| DIANAL | | — | — | — | 24.00 | 24.00 | 24.00 | — |
| PB-204 | | | | | | | | |
| Fluorescent | | 0.70 | 1.30 | 2.00 | 0.90 | 1.10 | 1.30 | 1.10 |
| Brightener | | | | | | | | |
| 140 | | | | | | | | |
| Tetrabutyl | | 2.80 | 2.80 | 2.80 | — | — | — | — |
| ammonium | | | | | | | | |
| bromide | | | | | | | | |
| Tetrapropyl | | — | — | — | 1.90 | 1.90 | 1.90 | 2.50 |
| ammonium | | | | | | | | |
| bromide | | | | | | | | |
| Total | | 100 | 100 | 100.00 | 100.00 | 100.00 | 100.00 | 100.00 |
| Relative | 1.0 | 2.4 | 2.6 | 2.2 | 3.0 | 3.1 | 2.8 | 2.5 |
| Fluorescent | | | | | | | | |
| Intensity | | | | | | | | |
| (Ratio to | | | | | | | | |
| Dye A) | | | | | | | | |
| Ink | | Not | 4.2 | Not | Not | 4.1 | 4.0 | 4.1 |
| viscosity | | tested | | tested | tested | | | |
| (25 C., cP) | | | | | | | | |
| Ink | | Not | 1334 | Not | Not | 1199 | 1191 | 1237 |
| resistivity | | tested | | tested | tested | | | |
| (Ohms-cm) | | | | | | | | |

### Example C

The below table shows the average molecular weights of indicated resins as measured by GPC, using polystyrene as the standard.

| | |
|---|---|
| Ave. Mn | Ave. Mw |

| | | | | |
|---|---|---|---|---|
| JONCRYL 67 | 6 | k | 13 | k |
| DIANAL PB-204 | 5 | k | 10 | k |
| SAA 100 | 2 | k | 4 | k |
| CAB551-0.01 | 10 | k | 30 | k |

### Example D

Ink jet ink formulations Examples 8-16 were prepared in accordance to the components and amounts listed in the below table. The general procedures for preparing these ink jet ink formulations included the following steps: 1) dissolving all of the components one by one in the ink vehicle with mixing; and 2) filtering the ink solution.

Example D illustrates that in general fluorescent intensity increases with increasing total solids at the same dye concentration.

| Example/% | Ex. 8 | Ex. 9 | Ex. 10 | Ex. 11 | Ex. 12 | Ex. 13 | Ex. 14 | Ex. 15 | Ex. 16 |
|---|---|---|---|---|---|---|---|---|---|
| MEK | 57.16 | 54.35 | 50.83 | 57.16 | 54.35 | 50.83 | 57.16 | 54.35 | 50.83 |
| SDA-3C (Ethanol) | 11.53 | 10.96 | 10.25 | 11.53 | 10.96 | 10.25 | 11.53 | 10.96 | 10.25 |
| Isopropyl Acetate | 12.50 | 11.89 | 11.12 | 12.50 | 11.89 | 11.12 | 12.50 | 11.89 | 11.12 |
| JONCRYL 67 | 15.00 | 19.00 | 24.00 | — | — | — | — | — | — |
| SAA100 | — | — | — | 15.00 | 19.00 | 24.00 | — | — | — |
| CAB551-0.01 | — | — | — | — | — | — | 15.00 | 19.00 | 24.00 |
| Fluorescent | 1.30 | 1.30 | 1.30 | 1.30 | 1.30 | 1.30 | 1.30 | 1.30 | 1.30 |
| Brightener 140 | | | | | | | | | |
| Tetrapropylammonium | 2.50 | 2.50 | 2.50 | 2.50 | 2.50 | 2.50 | 2.50 | 2.50 | 2.50 |
| bromide | | | | | | | | | |
| Total solids | 18.80 | 22.80 | 27.80 | 18.80 | 22.80 | 27.80 | 18.80 | 22.80 | 27.80 |
| Total | 100.00 | 100.00 | 100.00 | 100.00 | 100.00 | 100.00 | 100.00 | 100.00 | 100.00 |
| Relative Fluorescent | 2.0 | 2.2 | 2.6 | 2.8 | 2.9 | 2.9 | 2.7 | 2.9 | 3.2 |
| Intensity | | | | | | | | | |
| (Ratio to Dye A) | | | | | | | | | |

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, or compositions, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

What is claimed is:

1. An ink jet ink composition comprising:
a fluorescent colorant comprising a coumarin,
a solvent,
a binder resin, and
a conductive agent.

2. The ink jet ink composition of claim 1, wherein the coumarin comprises a 7-hydroxy coumarin or a 7-(substituted amino) coumarin.

3. The ink jet ink composition of claim 1, wherein the coumarin comprises 7-diethylamino-4-methylcoumarin.

4. The ink jet ink composition of claim 1, wherein the coumarin does not comprise 3-phenyl-7-(1,2H-napthotriazolyl)-coumarin and/or the fluorescent colorant does not comprise 3-phenyl-7-(1,2H-napthotriazolyl)-coumarin.

5. The ink jet ink composition of claim 1, wherein the fluorescent colorant has one or more of:
(a) a wavelength of maximum absorption from about 330 nm to about 400 nm; and
(b) a peak emission wavelength of from about 400 nm to about 600 nm.

6. The ink jet ink composition of claim 1, wherein the fluorescent colorant is present in amount of from about 0.3% to about 5% by weight of the composition.

7. The ink jet ink composition of claim 1, wherein the solvent comprises methyl ethyl ketone, methyl propyl ketone, diethyl ketone, methyl isopropyl ketone, cyclohexanone, cyclopentanone, acetone, ethanol, n-propanol, iso-propanol, n-butanol, methyl acetate, ethyl acetate, n-propyl acetate, isopropyl acetate, ethyl lactate, butyl lactate, propylene glycol, and propylene glycol methyl ether acetate

8. The ink jet ink composition of claim 1, wherein the solvent is present in an amount of from about 50% to about 90% by weight of the composition.

9. The ink jet ink composition of claim 1, wherein the binder resin comprises one or more of acrylic resins, styrene acrylic resins, copolymer of styrene and allyl alcohol, ketone resins, aldehyde resins, polyketone resins, natural resins or modified natural resins, sulfonamide resin, sulfonamide-formaldehyde resin, toluene-sulfonamide resin, bisphenol A toluene sulfonamide resin, cellulose esters, cellulose ethers, polyvinyl butyral, polyurethane, phenolic resin, modified phenolic resin, polyamide resins, vinyl resins for example copolymers of vinyl chloride and vinyl acetate with or without a third monomer, polyvinyl alcohol, polyvinyl acetate, nitrocellulose resin, polyester resins, and any combinations thereof.

10. The ink jet ink composition of claim 1, wherein the binder resin does not comprise nitrocellulose.

11. The ink jet ink composition of claim 1, wherein the binder resin comprises one or more binder resins having a weight average molecular weight of less than about 50,000 Dalton.

12. The ink jet ink composition of claim 1, wherein the binder resin is present in an amount of from about 10% to about 30% by weight of the composition.

13. The ink jet ink composition of claim 1, wherein the conductive agent comprises one or more of an organic ammonium salt, an organic bromide salt, an organic phosphonium salt, an organic borate salt and an organic phosphate salt.

14. The ink jet ink composition of claim 1, wherein the conductive agent comprises one or more of a tetraalkylammonium salt.

15. The ink jet ink composition of claim 1, wherein the conductive agent is present in an amount of from about 0.5% to about 5% by weight of the composition.

16. The ink jet ink composition of claim 1, further comprising one or more of a humectant, a co-solvent, a co-resin, a defoamer, an adhesion promoter, a plasticizer, a dispersing agent, a surfactant, and a corrosion inhibitor.

17. An ink jet ink composition comprising:
a fluorescent colorant comprising a 7-hydroxy coumarin or a 7-(substituted amino) coumarin,
a solvent,
a binder resin, and
a conductive agent.

18. The ink jet ink composition of claim 17, wherein the fluorescent colorant has one or more of:
(a) a wavelength of maximum absorption from about 330 nm to about 400 nm; and
(b) a peak emission wavelength of from about 400 nm to about 600 nm.

19. An ink jet ink composition comprising:
a fluorescent colorant comprising 7-diethylamino-4-methylcoumarin,
a solvent,
a binder resin, and
a conductive agent.

20. The ink jet ink composition of claim 19, wherein the fluorescent colorant has one or more of:
(a) a wavelength of maximum absorption from about 330 nm to about 400 nm; and
(b) a peak emission wavelength of from about 400 nm to about 600 nm.
